(19) United States
(12) Patent Application Publication
(10) Pub. No.: US 2006/0036713 A1
(43) Pub. Date: Feb. 16, 2006

(54) Method, system and program product for configuring an event management system

(75) Inventors: Carlos Cesar F. Araujo, Cary, NC (US); Jason H. Cornpropst, Mebane, NC (US); Denilson Nastacio, Apex, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/914,914

(22) Filed: Aug. 10, 2004

(51) Int. Cl. G06F 15/177

(52) U.S. Cl. 709/220

(57) ABSTRACT

An improved solution for configuring an event management system. In particular, a correlation rule can be deployed based on metadata for the correlation rule and/or a correlation engine. The metadata can describe one or more capabilities of the corresponding correlation rule/correlation engine. As a result, the combined capabilities can be readily considered when deploying the correlation rule.

### BACKGROUND OF THE INVENTION

1. Technical Field

The invention relates generally to event management, and more particularly, to an improved solution for deploying correlation rules for use by one or more correlation engines in an event management system.

2. Background Art

In an information technology (IT) environment, an event management solution (EMS) can provide information (data) that allows operations staff to manage the IT environment of one or more customers. In particular, the events and corresponding data generated within the IT environment can be monitored by the EMS to ensure that the various systems in the IT environment operate efficiently and effectively. This enables the EMS to provide the operations staff with timely warning of impending problems, notification of failing processes, identification of problem areas in a system, and the like. Further, the EMS may be able to automatically fix one or more problems before service availability for the IT environment falls below acceptable levels.

An “event” comprises an individual data entity corresponding to some information generated by an event source. Frequently, an EMS processes a very large number of events, e.g., millions a day, for a particular IT environment. As a result, an EMS may use a correlation engine that can process one or more types of events without requiring human intervention. A typical correlation engine executes one or more correlation rules for processing events.

However, several problems may exist with the deployment and/or use of the correlation rules. For example, a correlation rule may not support transactions, whereby a partially completed set of actions can be rolled back. Further, the correlation rule may require events to arrive in a particular order. This can limit the effectiveness of incorporating multiple parallel event servers in an EMS.

Various other problems also exist. For example, a correlation rule may require access to all events/event data throughout an IT environment, thereby inhibiting efficient scaling of the IT environment. In order to ensure the correct processing of these correlation rules a single correlation engine is frequently used for the entire IT environment. However, this implementation severely limits scalability of the IT environment. Various solutions, such as event filtering, also can be used to increase the scalability, but each of these solutions increase the complexity of administering the IT environment.

Further, a correlation rule may not support “failover,” which allows control to automatically switch to a redundant correlation engine when a currently active correlation engine fails. In this case, deployment of the correlation rule to redundant correlation engines would result in duplicate actions being performed due to the same event/series of events. One solution to this problem is the use of cold-start failover mechanisms in which a correlation engine is started after the active correlation engine has failed. However, this solution introduces a blackout window in the operation of the correlation engine, which is particularly damaging for correlation rules based on state machines.

Due to the various limitations that may be present in correlation rules and/or correlation engines, network administrators or the like have typically chosen a “least common denominator” approach when configuring event management systems. In particular, event management systems frequently only include a single correlation engine. However, customers often desire that the EMS perform without disruptions under high demand situations. Further, customers have requirements that are continually expanding and/or contracting. To this extent, the EMS should be both reliable and scalable to readily meet a customer's needs. However, without having ready access to information on the various capabilities of correlation rules and/or correlation engines, configuring the EMS to incorporate these capabilities without causing incorrect functioning of the EMS becomes very complex.

As a result, a need exists for an improved solution for configuring an event management system. In particular, a need exists for a method, system and program product that incorporate rule metadata and/or engine metadata in the deployment of correlation rules in the event management system.

### SUMMARY OF THE INVENTION

The invention provides an improved solution for configuring an event management system. Specifically, under the present invention, a correlation rule can be deployed based on metadata for the correlation rule and/or one or more correlation engines in the event management system. The metadata can describe one or more capabilities of the corresponding correlation rule/correlation engine. In this manner, the capabilities of each correlation engine can be matched with the correlation rule so that one or more desired functions are implemented for each deployed correlation rule.

A first aspect of the invention provides a method of configuring an event management system, the method comprising: obtaining rule metadata for at least one correlation rule, wherein the rule metadata describes a capability of the at least one correlation rule; obtaining engine metadata for at least one correlation engine, wherein the engine metadata describes a capability of the at least one correlation engine; and configuring the event management system based on the rule metadata and the engine metadata.

A second aspect of the invention provides a method of deploying a correlation rule, the method comprising: obtaining rule metadata for the correlation rule, wherein the rule metadata describes a capability of the correlation rule; obtaining engine metadata for at least one correlation engine, wherein the engine metadata describes a capability of the at least one correlation engine; and deploying the correlation rule to the at least one correlation engine based on at least one of the rule metadata and the engine metadata.

A third aspect of the invention provides a system for managing events, the system comprising: a rule system for obtaining rule metadata for a correlation rule, wherein the rule metadata describes a capability of the correlation rule; an engine system for obtaining engine metadata for a correlation engine, wherein the engine metadata describes a capability of the correlation engine; and a deployment system for deploying the correlation rule to the correlation engine based on at least one of the rule metadata and the engine metadata.

A fourth aspect of the invention provides a program product stored on a recordable medium for deploying a correlation rule, which when executed comprises: program code for obtaining rule metadata for the correlation rule, wherein the rule metadata describes a capability of the correlation rule; program code for obtaining engine metadata for at least one correlation engine, wherein the engine metadata describes a capability of the at least one correlation engine; and program code for deploying the correlation rule to the at least one correlation engine based on at least one of the rule metadata and the engine metadata.

A fifth aspect of the invention provides a system for deploying an application for configuring an event management system, the system comprising: a computer infrastructure being operable to: obtain rule metadata for at least one correlation rule, wherein the rule metadata describes a capability of the at least one correlation rule; obtain engine metadata for at least one correlation engine, wherein the engine metadata describes a capability of the at least one correlation engine; and configure the event management system based on the rule metadata and the engine metadata.

A sixth aspect of the invention provides computer software embodied in a propagated signal for configuring an event management system, the computer software comprising instructions to cause a computer system to perform the following functions: obtain rule metadata for at least one correlation rule, wherein the rule metadata describes a capability of the at least one correlation rule; obtain engine metadata for at least one correlation engine, wherein the engine metadata describes a capability of the at least one correlation engine; and configure the event management system based on the rule metadata and the engine metadata.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing events;

FIG. 2 shows an illustrative data flow diagram for managing an event using the system of FIG. 1;

FIG. 3 shows an illustrative data flow diagram for deploying a correlation rule using the system of FIG. 1; and

FIG. 4 shows an illustrative matrix for comparing a correlation engine and correlation rule capability.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved solution for configuring an event management system. Specifically, under the present invention, a correlation rule can be deployed based on metadata for the correlation rule and/or one or more correlation engines in the event management system. The metadata can describe one or more capabilities of the corresponding correlation rule/correlation engine. In this manner, the capabilities of each correlation engine can be matched with the correlation rule so that one or more desired functions are implemented for each deployed correlation rule.

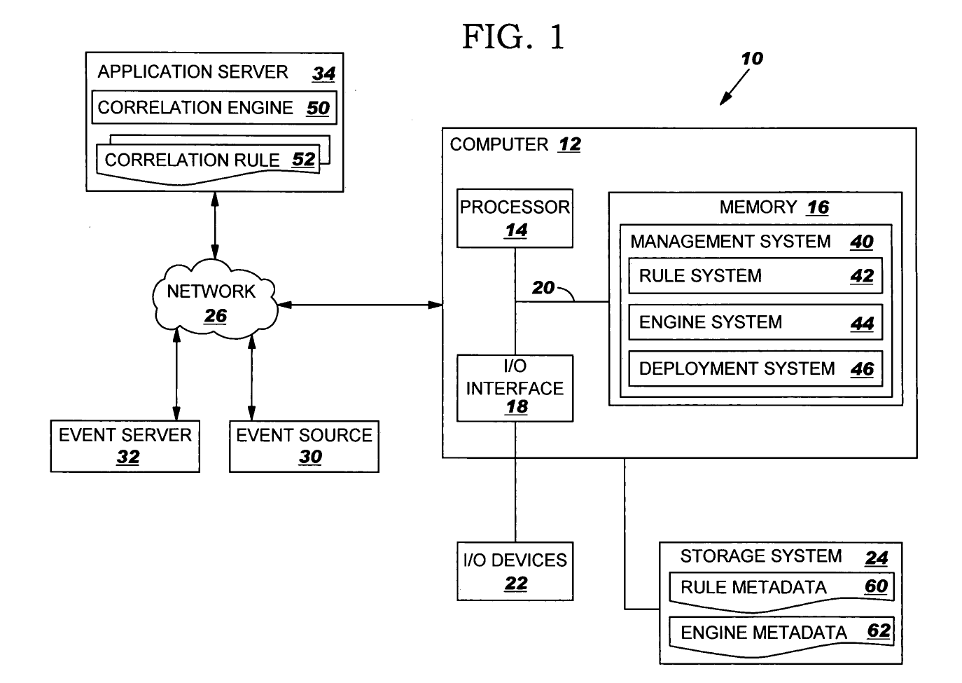

Turning to the drawings, FIG. 1 shows an illustrative system 10 for managing events. In particular, an event source 30 can generate an event that is processed by an event server 32. Event server 32 can provide the event and/or data on the event to one or more application servers 34 for further processing. It is understood that while only one event source 30, one event server 32, and one application server 34 are shown and described in system 10, any number of each can be included in a typical event management system 10.

In one embodiment, event server 32 comprises a Websphere Application Server® sold by International Business Machines Corp. of Armonk, N.Y. (IBM), which can be executing a standard Java 2 Platform, Enterprise Edition (J2EE) application for processing an event. To this extent, the event can be communicated from event source 30 to event server 32 using a Java Message Service (JMS) queue or the like. Further, the event and/or event data can be communicated from event server 32 to one or more application servers 34 using a JMS Publish/Subscribe (JMS Pub/Sub) system or the like.

Application server 34 is shown including a correlation engine 50 that applies a set (one or more) of correlation rules 52 when processing an event. In general, each correlation rule 52 defines one or more actions that may be performed in response to a set of events. It is understood that an action can comprise any type of response. For example, correlation rule 52 may generate a new event based on a series of events that have been received. Further, correlation rule 52 may update event data for a previously received event, update an internal state of correlation engine 50 (e.g., a state machine), or the like.

While a typical system 10 can manage network events, it is understood that the teachings of the invention are not limited to this particular embodiment. For example, correlation engine 50 and correlation rule(s) 52 could be used to manage one or more business processes. In this case, each event could comprise a business transaction (e.g., account withdrawal, payment, etc.) or the like. To this extent, correlation rule 52 could define an action for executing a business rule in response to a set of events (business transactions). For example, correlation rule 52 could generate an automatic fee withdrawal for an account in response to a withdrawal transaction for the account that is processed from another institution.

Regardless, communications between event source 30, event server 32, application server 34, and/or computer 12 (described further below) can occur over network 26. To this extent, network 26 can comprise any type of communications link. For example, network 26 can comprise an addressable connection in a client-server (or server-server) environment that may utilize any combination of wire line and/or wireless transmission methods. In this instance, event source 30, event server 32, application server 34, and/or computer 12 may utilize conventional network connectivity, such as Token Ring, Ethernet, WiFi or other conventional communications standards. Further, network 26 can comprise one or more of various types of networks, including the Internet, a wide area network (WAN), a local area network (LAN), a virtual private network (VPN), etc. Where communications occur via the Internet, connectivity for one or more of the computing devices could be provided by conventional TCP/IP sockets-based protocol, and a computing device could utilize an Internet service provider to establish connectivity to network 26.

It is understood that each of event source 30, event server 32, application server 34, and computer 12 comprises any type of computing device capable of communicating with one or more other computing devices and/or interacting with one or more users. Various types of computing devices include a server, a desktop computer, a laptop computer, a handheld device, a mobile phone, a pager, a personal data assistant, etc. To this extent, computer 12 is shown including a processor 14, a memory 16, an input/output (I/O) interface 18, a bus 20, external I/O devices/resources 22, and a storage system 24. In general, processor 14 executes computer program code, such as management system 40, that is stored in memory 16 and/or storage system 24. While executing computer program code (e.g., management system 40), processor 14 can read and/or write data to/from memory 16, storage system 24, and/or I/O interface 18. Bus 20 provides a communication link between each of the components in computer 12.

It is understood that computer 12 is only illustrative of various possible combinations of hardware. For example, processor 14 may comprise a single processing unit, or be distributed across one or more processing units in one or more locations, e.g., on a client and server. Similarly, memory 16 and/or storage system 24 can comprise any combination of various types of data storage and/or transmission media that reside at one or more physical locations. I/O interface 18 can comprise any system for exchanging information with one or more I/O devices 22 that can provide an interface with one or more other computing devices (e.g., application server 34) and/or users. It is understood, however, that if computer 12 comprises a handheld device or the like, one or more I/O devices 22 (e.g., a display) could be contained within computer 12, and not as an external I/O device 22 as shown. Further, it is understood that event source 30, event server 32, and application server 34 typically include similar elements (e.g., processor, memory, I/O interface, etc.) as shown for computer 12. These have not been separately shown and described for brevity.

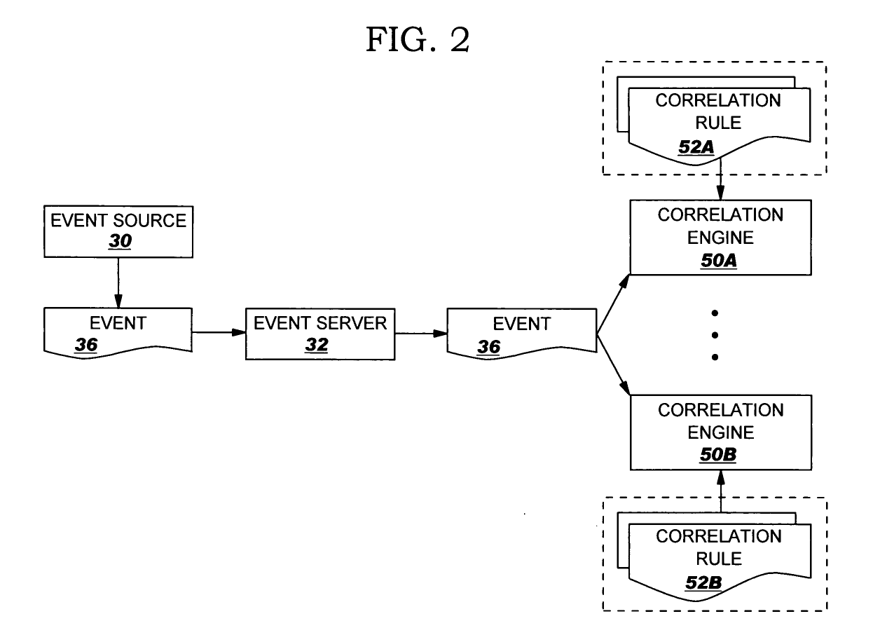

FIG. 2 shows an illustrative data flow diagram for managing an event 36 using system 10 (FIG. 1). In particular, event source 30 generates event 36, which is received by event server 32 and processed. For example, event server 32 can determine a set of recipients for event 36, add/remove data from event 36, generate new data based on event 36, etc. Regardless, event server 32 can provide event 36 (or event data) to one or more correlation engines 50A-B. When each correlation engine 50A-B receives event 36, it will determine if one or more correlation rules 52A-B should be applied to event 36. Subsequently, for each correlation rule 52A-B that is applied to event 36, correlation engine 50A-B will perform the corresponding action.

Returning to FIG. 1, a network administrator (not shown) or the like can configure system 10 using computer 12. In particular, management system 40 can configure system 10 based on rule metadata 60 and/or engine metadata 62. To this extent, management system 40 is shown including a rule system 42 for obtaining rule metadata 60, an engine system 44 for obtaining engine metadata 62, and a deployment system 46 for deploying correlation rule(s) 52 based on rule metadata 60 about correlation rule(s) 52 and/or engine metadata 62 about correlation engine(s) 50. It is understood that some of the various systems shown in FIG. 1 can be implemented independently and/or combined. Further, it is understood that some of the systems and/or functionality may not be implemented, or additional systems and/or functionality may be included as part of system 10. For example, management system 40 can include one or more systems for starting/stopping correlation engine(s) 50, event server(s) 32, etc.

Management system 40 can perform various operations to configure system 10. For example, engine system 44 can also generate and/or obtain correlation engine 50, and rule system 42 can also generate and/or obtain one or more correlation rules 52. Any solution for generating correlation engine 50 and/or correlation rule 52 can be used. For example, when correlation engine 50 and/or correlation rule 52 comprises computer program code, engine system 44 and/or rule system 42 can comprise an integrated development environment (IDE) such as Websphere® Studio Application Developer offered by IBM. Alternatively, correlation engine 50 and/or correlation rule 52 can be generated apart from management system 40, and provided to management system 40 for use by engine system 44 and/or rule system 42, respectively.

In any event, deployment system 46 can deploy one or more correlation engines 50 and/or one or more correlation rules 52 in system 10. It is understood that any number of unique correlation engines 50/correlation rules 52 and instances of the same correlation engine 50/correlation rule 52 can be deployed in system 10. For example, system 10 could comprise a distributed event management system that comprises multiple application servers 34, each with one or more correlation engines 50 having one or more correlation rules 52.

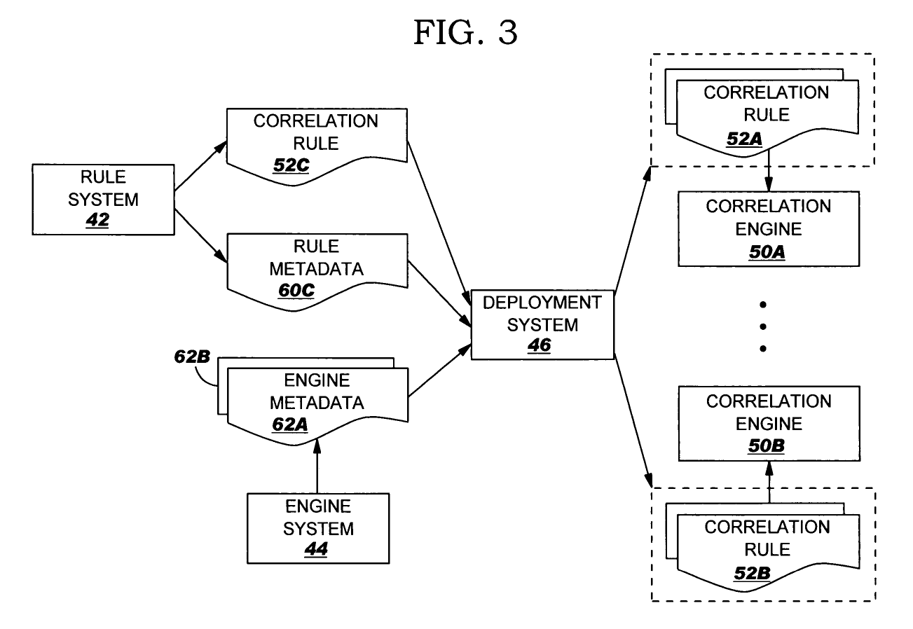

In order to assist in the deployment of correlation rules 52, deployment system 46 can use rule metadata 60 and/or engine metadata 62. To this extent, FIG. 3 shows an illustrative data flow diagram for deploying a correlation rule 52C using system 10 (FIG. 1). As shown, rule system 42 can provide correlation rule 52C together with its corresponding rule metadata 60C to deployment system 46. Rule metadata 60C describes at least one capability of correlation rule 52C that may impact a determination of how correlation rule 52C is deployed in system 10. For example, rule metadata 60C can describe whether correlation rule 52C: (1) depends on a pre-specified sequence of events 36 (FIG. 2), e.g., a state machine; (2) can recover its state after a corresponding correlation engine 50A-B has crashed; (3) requires events 36 to arrive in a particular order; (4) can roll back partially completed actions when required; and (5) can hold actions as part of a stand by correlation engine 50A-B until the failure of a primary engine hosting an identical copy of correlation rule 52C. It is understood that this list is only illustrative, and more or less capabilities could be described by rule metadata 60C.

Rule system 42 can generate rule metadata 60C based on correlation rule 52C using any known solution. For example, rule metadata 60C could be generated at the same time that correlation rule 52C is generated. To this extent, rule metadata 60C could comprise a portion of correlation rule 52C. Alternatively, a network administrator or the like could answer a series of questions based on his/her knowledge of the capabilities of correlation rule 52C. When rule metadata 60C is generated apart from the corresponding correlation rule 52C, rule metadata 60C can be associated with correlation rule 52C using any known solution, such as inclusion of an identifier for correlation rule 52C as part of rule metadata 60C. To this extent, rule metadata 60C can be stored in any known format such as, for example, one or more database entries, an extensible markup language (XML) file, or the like.

Engine system 44 can also provide engine metadata 62A-B to deployment system 46 for use in deploying correlation rule 52C. To this extent, engine system 44 can generate and/or obtain engine metadata 62A-B for each correlation engine 50A-B in system 10 (FIG. 1). Similar to rule metadata 60C, engine metadata 62A-B can describe one or more capabilities of the corresponding correlation engine 50A-B. For example, engine metadata 62A-B can describe whether the corresponding correlation engine 50A-B: (1) supports correlation rules 52A-C that cannot rebuild their state after a system crash; (2) can compensate for changes in the order of arrival of a series of events 36 (FIG. 2); (3) can interact with correlation rules 52A-C that support transactions (e.g., using the XA protocol); and (4) can comprise a stand by correlation engine in case a primary correlation engine crashes. As with rule metadata 60C, it is understood that this list is only illustrative, and more or less capabilities could be described by engine metadata 62A-B. Further, engine metadata 62A-B can be generated and/or associated with a corresponding correlation engine 50A-B in the same manner as described above with reference to correlation rule 52C and rule metadata 60C. This has not been separately discussed for brevity.

Rule metadata 60C and/or engine metadata 62A-B can also comprise additional data. For example, rule system 42 can include in rule metadata 60C a list of events 36 (FIG. 2) and/or event types that trigger its execution. This data could be used appropriately deploy the corresponding correlation rule 52C to an appropriate correlation engine 50A-B that will receive the specified events 36 and/or event types. Similarly, engine system 44 can include a list of correlation rules 52A-C that are currently deployed to the corresponding correlation engine 50A-B in engine metadata 62A-B. This list can be used to determine where each correlation rule 52A-C is currently deployed, and determine the appropriate correlation engine(s) 50A-B for deployment of another correlation rule 52A-C.

In any event, deployment system 46 can obtain rule metadata 60C for correlation rule 52C and engine metadata 62A-B for each correlation engine 50A-B in system 10 (FIG. 1). Subsequently, deployment system 46 can deploy correlation rule 52C to one or more correlation engines 50A-B based on rule metadata 60C and/or engine metadata 62A-B. To this extent, deployment system 46 can determine if a combination of a particular correlation engine 50A-B and correlation rule 52C provides a desired function. Based on the result(s) of this determination, correlation rule 52C can be automatically deployed to each correlation engine 50A-B for which the combination provides the desired function.

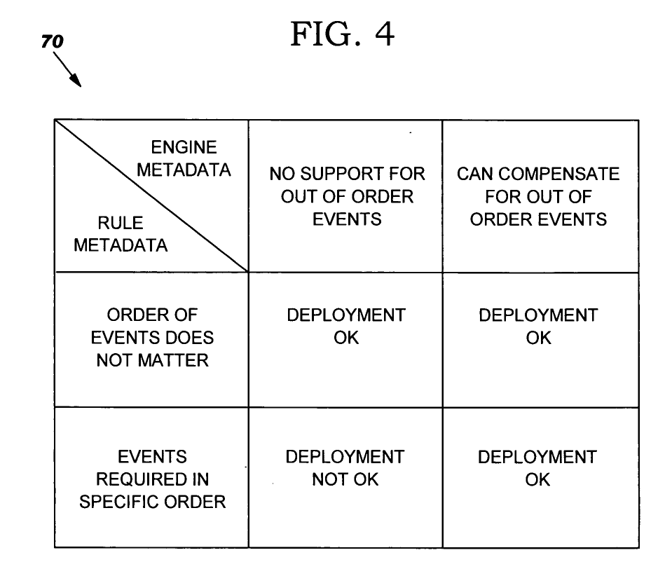

In one embodiment, deployment system 46 can use a matrix of possible values for one or more capabilities in engine metadata 62A-B versus possible values for one or more capabilities in rule metadata 60C. Each combination of possible values can indicate whether a deployment of correlation rule 52C to the corresponding correlation engine 50A-B would be desirable. For example, FIG. 4 shows an illustrative matrix 70 for the order sensitivity capabilities described above, and will be discussed in conjunction with FIG. 3. In particular, engine metadata 62A-B can include an indication as to whether the corresponding correlation engine 50A-B can compensate for events that arrive out of order from their occurrence. Similarly, rule metadata 60C can include an indication as to whether the corresponding correlation rule 52C must receive events in the order that they occurred. In this case, when rule metadata 60C indicates that events are required in a particular order, and engine metadata 62A-B indicates that the corresponding correlation engine 50A-B does not compensate for out of order events, deployment of correlation rule 52C to correlation engine 50A-B would not be recommended.

Similar matrices 70 can be constructed for other combinations of capabilities. For example, rule metadata 60C and engine metadata 62A-B can be used to determine if the state of correlation rule 52C will be saved and restored in the event of a system crash. In this case, a corresponding matrix 70 would indicate that when rule metadata 60C indicates that correlation rule 52C expects the correlation engine 50A-B to handle the save and restore function, correlation rule 52C should not be deployed to correlation engines 50A-B that do not implement this function. It is understood that these examples are only illustrative, and any type, number, and/or combination of capabilities can be considered when deploying correlation rule 52C.

Referring back to FIG. 3, deployment system 46 can use engine metadata 62A-B to obtain additional data about system 10 (FIG. 1). For example, deployment system 46 can determine a number of correlation engines 50A-B at which correlation rule 52C is currently deployed. Based on this number, correlation rule 52C may not be deployed to any additional correlation engines 50A-B. For example, when rule metadata 60C indicates that correlation rule 52C does not support primary/stand by modes, it may be necessary to limit the deployment of correlation rule 52C to a single correlation engine 50A-B.

In any event, deployment system 46 makes decisions based on rule metadata 60C and/or engine metadata 62A-B. As discussed above, deployment system 46 can automatically deploy correlation rule 52C to one or more correlation engines 50A-B. Alternatively, deployment system 46 can automatically generate a deployment recommendation based on rule metadata 60C and/or engine metadata 62A-B. The deployment recommendation can be displayed to an administrator or the like and be used to obtain the proper configuration of system 10 (FIG. 1). For example, as discussed above, the administrator may attempt to deploy correlation rule 52C, and engine metadata 62A-B may indicate that it has already been deployed to one correlation engine 50A-B for system 10. When rule metadata 60C indicates that correlation rule 52C does not support primary/stand by modes, deployment system 46 can generate a deployment recommendation that correlation rule 52C not be deployed a second time in order to prevent duplicate actions from being performed for the same set of events.

It should be appreciated that the teachings of the present invention could be offered as a business method on a subscription or fee basis. For example, management system 40 could be created, maintained and/or deployed by a service provider that offers the functions described herein for customers. That is, a service provider could offer to configure an event management system as described above. It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention also can be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of configuring an event management system, the method comprising:
obtaining rule metadata for at least one correlation rule, wherein the rule metadata describes a capability of the at least one correlation rule;
obtaining engine metadata for at least one correlation engine, wherein the engine metadata describes a capability of the at least one correlation engine; and
configuring the event management system based on the rule metadata and the engine metadata.

2. The method of claim 1, wherein the configuring step includes deploying the at least one correlation rule to the at least one correlation engine based on at least one of the rule metadata and the engine metadata.

3. The method of claim 1, wherein the configuring step includes determining if a combination of the at least one correlation engine and the correlation rule provides a desired function.

4. The method of claim 1, wherein the configuring step includes determining a number of the at least one correlation engine at which the at least one correlation rule is deployed.

5. The method of claim 1, further comprising deploying a plurality of correlation engines in a distributed event management system.

6. The method of claim 1, wherein the configuring step includes automatically generating a deployment recommendation based on at least one of the rule metadata and the engine metadata.

7. The method of claim 1, further comprising generating the at least one correlation rule.

8. The method of claim 1, wherein the obtaining rule metadata step includes:
generating the rule metadata based on the at least one correlation rule; and
associating the rule metadata with the at least one correlation rule.

9. The method of claim 1, wherein the obtaining engine metadata step includes:
generating the engine metadata based on the at least one correlation engine; and
associating the engine metadata with the at least one correlation engine.

10. A method of deploying a correlation rule, the method comprising:
obtaining rule metadata for the correlation rule, wherein the rule metadata describes a capability of the correlation rule;
obtaining engine metadata for at least one correlation engine, wherein the engine metadata describes a capability of the at least one correlation engine; and
deploying the correlation rule to the at least one correlation engine based on at least one of the rule metadata and the engine metadata.

11. The method of claim 10, wherein the deploying step includes determining if a combination of each of the at least one correlation engine and the correlation rule provides a desired function.

12. The method of claim 11, wherein the deploying step further includes automatically deploying the correlation rule to each of the at least one correlation engine for which the combination provides the desired function.

13. The method of claim 10, wherein the deploying step includes:
determining a number of correlation engines at which the correlation rule is deployed; and
generating a deployment recommendation based on the number and the rule metadata.

14. A system for managing events, the system comprising:
a rule system for obtaining rule metadata for a correlation rule, wherein the rule metadata describes a capability of the correlation rule;
an engine system for obtaining engine metadata for a correlation engine, wherein the engine metadata describes a capability of the correlation engine; and
a deployment system for deploying the correlation rule to the correlation engine based on at least one of the rule metadata and the engine metadata.

15. The system of claim 14, further comprising a plurality of distributed correlation engines, wherein each of the plurality of distributed correlation engines has associated engine metadata.

16. The system of claim 14, wherein the events comprise at least one of business events and network events.

17. The system of claim 14, further comprising at least one event server for forwarding an event to the correlation engine.

18. The system of claim 14, further comprising at least one event source for generating an event.

19. A program product stored on a recordable medium for deploying a correlation rule, which when executed comprises:
program code for obtaining rule metadata for the correlation rule, wherein the rule metadata describes a capability of the correlation rule;
program code for obtaining engine metadata for at least one correlation engine, wherein the engine metadata describes a capability of the at least one correlation engine; and
program code for deploying the correlation rule to the at least one correlation engine based on at least one of the rule metadata and the engine metadata.

20. The program product of claim 19, wherein the program code for deploying includes program code for determining if a combination of each of the at least one correlation engine and the correlation rule provides a desired function.

21. The program product of claim 20, wherein the program code for deploying further includes program code for automatically deploying the correlation rule to each of the at least one correlation engine for which the combination provides the desired function.

22. The program product of claim 19, wherein the program code for deploying includes:
program code for determining a number of correlation engines at which the correlation rule is deployed; and
program code for generating a deployment recommendation based on the number and the rule metadata.

23. A system for deploying an application for configuring an event management system, the system comprising:
a computer infrastructure being operable to:
obtain rule metadata for at least one correlation rule, wherein the rule metadata describes a capability of the at least one correlation rule;
obtain engine metadata for at least one correlation engine, wherein the engine metadata describes a capability of the at least one correlation engine; and
configure the event management system based on the rule metadata and the engine metadata.

24. Computer software embodied in a propagated signal for configuring an event management system, the computer software comprising instructions to cause a computer system to perform the following functions:
obtain rule metadata for at least one correlation rule, wherein the rule metadata describes a capability of the at least one correlation rule;
obtain engine metadata for at least one correlation engine, wherein the engine metadata describes a capability of the at least one correlation engine; and
configure the event management system based on the rule metadata and the engine metadata.
